(19) United States
(12) Patent Application Publication
(10) Pub. No.: US 2024/0118142 A1
(43) Pub. Date: Apr. 11, 2024

(54) INFRARED MODULE AND METHOD OF CORRECTING INFRARED MODULE

(71) Applicant: Asahi Kasei Microdevices Corporation, Tokyo (JP)

(72) Inventors: Yoshihiko KOIZUMI, Tokyo (JP); Masayuki SATO, Tokyo (JP)

(73) Assignee: Asahi Kasei Microdevices Corporation, Tokyo (JP)

(21) Appl. No.: 18/479,829

(22) Filed: Oct. 3, 2023

(30) Foreign Application Priority Data
Oct. 6, 2022 (JP) 2022-161874

(51) Int. Cl. G01J 5/24

(52) U.S. Cl. CPC G01J 5/24

(57) ABSTRACT

An infrared module that enables temperature regulation of an infrared sensor to be readily achieved and a method of correcting the infrared module are provided. The infrared module (10) includes an infrared sensor (11) that detects infrared radiation emitted from an object being measured, a computation and control processor (20) that includes a temperature measurement unit (22) that obtains a signal from the infrared sensor and measures a temperature of its own, the computation and control processor obtaining a temperature signal from the temperature measurement unit and performing a computation, and a heating element (60) that regulates a temperature of the infrared sensor by generating heat, wherein the infrared sensor and the computation and control processor are stacked.

### CROSS-REFERENCE OF RELATED APPLICATION

This application claims priority to Japanese Patent Application No. 2022-161874, filed Oct. 6, 2022, the entire disclosure of which is incorporated herein by reference.

### TECHNICAL FIELD

The present disclosure relates to an infrared module and a method of correcting an infrared module.

### BACKGROUND

Infrared radiation with a wavelength of 2 μm or longer is employed in human detection sensors for detecting human bodies, non-contact temperature measurement devices, and gas sensors based on the thermal effects of infrared radiation and absorption of infrared radiation by gases. For example, a non-contact temperature measurement device includes an infrared sensor to detect the intensity of energy of infrared radiation (referred to as infrared radiation intensity) coming from an object being measured, and then calculates the temperature based on the detected infrared radiation intensity.

Here, when infrared sensors are employed in non-contact temperature measurement devices, it is essential to perform temperature correction (calibration) after they are assembled into a device or electronic instrument to ensure accurate temperature measurements. For example, PTL 1 discloses a simple and highly accurate method for obtaining correction data to correct errors by taking external factors such as dirt into account.

### CITATION LIST

### Patent Literature

PTL 1: JP5520238B

### SUMMARY

Here, it has been known that the correspondence relationship (characteristic curve) between the infrared radiation intensity detected by an infrared sensor and the temperature of an object being measured, etc. depends on the temperature of the infrared sensor per se. Therefore, the temperature correction as set forth above needs to be performed when the temperature of the infrared sensor reaches a certain specific value (predetermined value). However, in a temperature correction which is performed after the infrared sensor is assembled into a device or electronic instrument, heat must be conducted from outside the device or electronic instrument, which makes it difficult to set the infrared sensor to the predetermined temperature.

An object of the present disclosure, which is conceived in light of such circumstances, is to provide an infrared module that enables temperature regulation of an infrared sensor to be readily achieved and a method for correcting the infrared module.

(1) An infrared module of one embodiment of the present disclosure comprises:
an infrared sensor that detects infrared radiation emitted from an object being measured;
a computation and control processor comprising a temperature measurement unit that obtains a signal from the infrared sensor and measures a temperature of its own, the computation and control processor obtaining a temperature signal from the temperature measurement unit and performing a computation; and
a heating element that regulates a temperature of the infrared sensor by generating heat,
wherein the infrared sensor and the computation and control processor are stacked.

(2) As an embodiment of the present disclosure, in (1),
a light-receiving element is disposed on a side of one surface of the infrared sensor,
the temperature measurement unit is disposed on a side of one surface of the computation and control processor, and
wherein the infrared sensor and the computation and control processor are stacked such that the side of the one surface of the infrared sensor and the side of the one surface of the computation and control processor face each other and the light-receiving element and the temperature measurement unit face each other and are in close proximity.

(3) As an embodiment of the present disclosure, in (1) or (2),
the heating element is disposed in the vicinity of a second surface of the computation and control processor opposite to a first surface that is in contact with the infrared sensor.

(4) As an embodiment of the present disclosure, in any one of (1) to (3),
a substrate comprising a terminal for conducting a current to the heating element is provided, and
the heating element is wiring disposed on a surface of the substrate in contact with the second surface, and the substrate having the heating element is packaged together with the infrared sensor and the computation and control processor.

(5) As an embodiment of the present disclosure, in (4),
a plurality of terminals for conducting the current to the heating element are disposed.

(6) As an embodiment of the present disclosure, in any one of (1) to (5),
the heating element is disposed so as to traverse the infrared sensor in plan view.

(7) A method of correcting an infrared module in accordance with one embodiment of the present disclosure is
a method of correcting an infrared module comprising an infrared sensor that detects infrared radiation emitted from an object being measured, a computation and control processor comprising a temperature measurement unit that obtains a signal from the infrared sensor and measures a temperature of its own, the computation and control processor obtaining a temperature signal from the temperature measurement unit and performing a computation, and a heating element that regulates a temperature of the infrared sensor by generating heat,
the method comprising the steps of, by the computation and control processor:
obtaining, when the temperature of the infrared sensor reaches a first predetermined value due to a temperature of the environment or heat of the heating element, a first infrared detection value of detected infrared radiation emitted from the object being measured and a first temperature detection value of the temperature measurement unit;
obtaining, when the temperature of the infrared sensor reaches a second predetermined value due to heat of the heating element, a second infrared detection value of detected infrared radiation emitted from the object being measured and a second temperature detection value of the temperature measurement unit; and
performing temperature correction based on the first infrared detection value, the first temperature detection value, the second infrared detection value, and the second temperature detection value,
wherein, in the infrared module,
the infrared sensor and the computation and control processor are stacked.

(8) As an embodiment of the present disclosure, in (7),
the infrared sensor and the computation and control processor are stacked so that a light-receiving element and the temperature measurement unit face each other and are in close proximity.

(9) As an embodiment of the present disclosure, in (7) or (8),
the heating element is disposed in the vicinity of a second surface of the computation and control processor opposite to a first surface that is in contact with the infrared sensor.

(10) As an embodiment of the present disclosure, in any one of (7) to (9),
a substrate comprising a terminal for conducting a current to the heating element is provided, and
the heating element is wiring disposed on a surface of the substrate in contact with the second surface, and the substrate having the heating element is packaged together with the infrared sensor and the computation and control processor.

According to the present disclosure, it is possible to provide an infrared module that enables temperature regulation of an infrared sensor to be readily achieved and a method of correcting an infrared module.

### BRIEF DESCRIPTION OF THE DRAWINGS

In the accompanying drawings:

FIG. 1 is a block diagram of one example configuration of an infrared module in accordance with one embodiment of the present disclosure;

FIG. 2 is a diagram illustrating an example use of the infrared module in accordance with one embodiment of the present disclosure;

FIG. 3 is a cross-sectional view of one example configuration of the infrared module in accordance with one embodiment of the present disclosure;

FIG. 4 is a diagram illustrating one example configuration of a heating element;

FIG. 5 is a diagram illustrating another example configuration of the heating element;

FIG. 6 is a flowchart illustrating the processes of a method of correcting an infrared module in accordance with an embodiment of the present disclosure; and

FIG. 7 is a diagram illustrating an example implementation of the infrared module in accordance with one embodiment of the present disclosure.

### DETAILED DESCRIPTION

Hereinafter, an infrared module and a method of correcting an infrared module in accordance with one embodiment of the present disclosure will be described with reference to the drawings. In the drawings, the same or similar portions are denoted by the like reference symbols. In the description of the present embodiment, description of the same or similar portions will be omitted or simplified as appropriate.

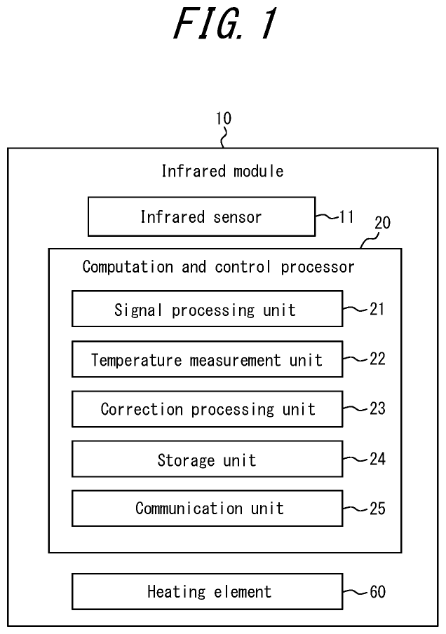

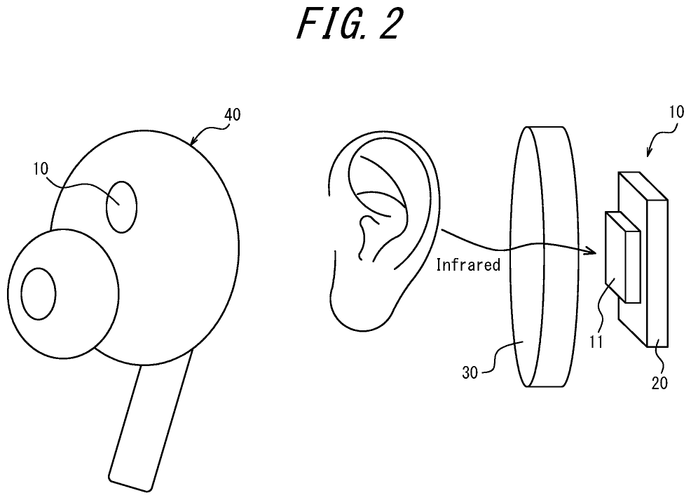

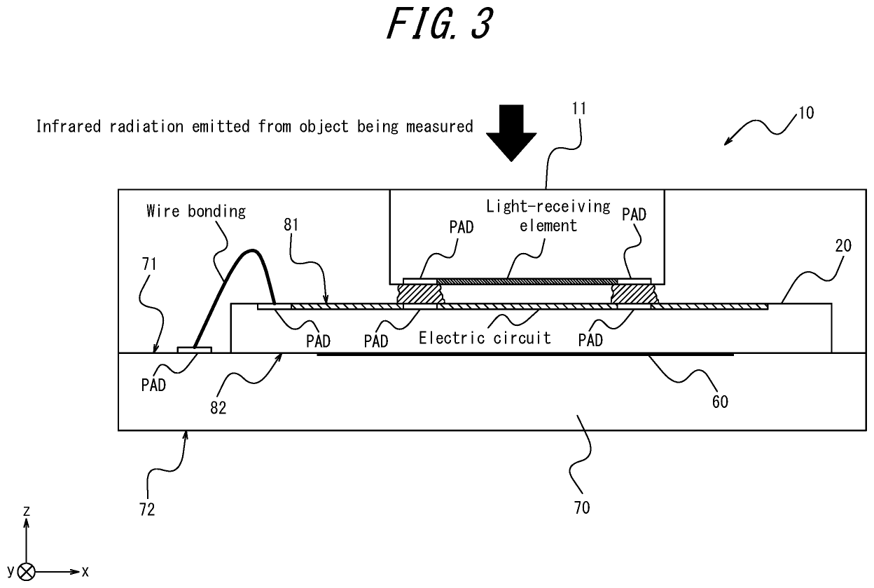

FIG. 1 is a block diagram of an infrared module 10 in accordance with the present embodiment. FIG. 2 is a diagram illustrating an example use of the infrared module 10. FIG. 3 is a cross-sectional view of the infrared module 10. In the present embodiment, the infrared module 10 is used as a non-contact temperature measurement device. However, the infrared module 10 is not limited to use as a non-contact temperature measurement device, and can be used as a wide variety of devices where temperature correction (calibration) is performed after the devices are assembled.

In addition, the infrared module 10 may be used after being embedded in a variety of electronic devices. In the present embodiment, the infrared module 10 is embedded into an earphone 40. As illustrated in FIG. 2, the portion of the earphone 40 where the infrared module 10 is disposed may be provided with a window material 30 to allow infrared radiation to pass through. The infrared module 10 measures the temperature (body temperature) of the user, and the operation of the earphone 40, such as powering on or off, may be controlled based on the measured temperature. Furthermore, the temperature correction of the infrared module 10 can be performed while it is embedded in the earphone 40, and may be performed before the earphone 40 is shipped after manufacturing or may be performed while it is being used.

As illustrated in FIG. 1, the infrared module 10 includes an infrared sensor 11, a computation and control processor 20, and a heating element 60. The computation and control processor 20 may include a signal processing unit 21, a temperature measurement unit 22, a correction processing unit 23, a storage unit 24, and a communication unit 25. Further, as illustrated in FIG. 3, the infrared module 10 also includes a substrate 70 in the present embodiment, and the infrared sensor 11, the computation and control processor 20, the heating element 60, and the substrate 70 are encapsulated and packaged with a resin. Furthermore, the electronic circuit in FIG. 3 includes the computation and control processor 20. Thus, the electronic circuit in FIG. 3 includes temperature measurement unit 22. Details of the elements of the infrared module 10 will be described below.

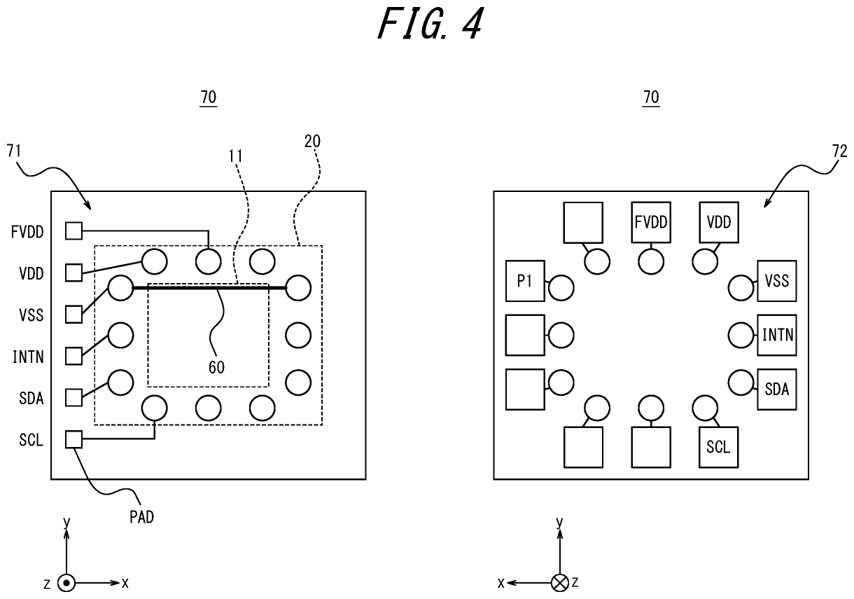

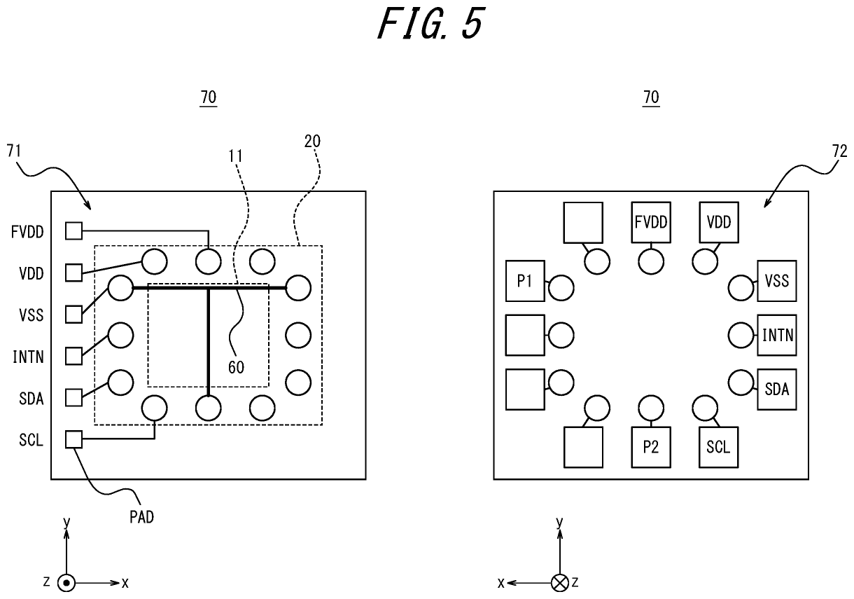

Here, the Cartesian coordinate illustrated in FIG. 3 is common to those in FIGS. 4 and 5. The z-axis direction is the direction along which the infrared sensor 11 and the computation and control processor 20 are stacked and can be referred to as the stacking direction. The z-axis direction is also the axial direction orthogonal to the main surfaces of the substrate 70. The main surfaces are the surface with the largest area. The y-axis direction corresponds to the direction of either sides of main surfaces of the substrate 70, which is rectangular. The x-axis direction corresponds to the direction of the other sides of the main surfaces of the substrate 70. The xy-plane is parallel to the main surfaces of the substrate 70. Furthermore, the positive direction of the z-axis may be referred to as “up,” and the negative direction of the z-axis is referred to as “down,” with this orientation corresponding to the vertical stacking direction. For example, the positional relationship of the infrared sensor 11, the computation and control processor 20, and the substrate 70 in FIG. 3 is such that the infrared sensor 11 is stacked above the computation and control processor 20 and the substrate 70 is below the computation and control processor 20. In addition, the perspective of viewing the xy-plane directly from the front is sometimes referred to as a “plan view” in the context below. For example, when viewed from a perspective towards the negative direction of the z-axis by allowing the infrared sensor 11 and the computation and control processor 20 to seen through, the perspective for explaining the positional relationship on the xy-plane on the main surfaces of the substrate 70 is a plan view.

The elements of the infrared module 10 will be described in detail below. The infrared sensor 11 detects infrared radiation emitted from an object being measured. The infrared sensor 11 outputs an electrical signal corresponding to the intensity of detected infrared radiation energy (hereafter referred to as “infrared radiation intensity”). The electrical signal corresponding to the infrared radiation intensity may be, for example, a current value. The infrared sensor 11 may be a quantum-type sensor that detects infrared radiation through the generation of electrons or holes in the semiconductor when irradiated with infrared radiation. Quantum-type sensors have higher sensitivity and faster response time than thermal-type infrared sensors.

The computation and control processor 20 includes the temperature measurement unit 22 that obtains signals from the infrared sensor 11 and measures the temperature of its own, and performs calculations by obtaining temperature signals from the temperature measurement unit 22. The computation and control processor 20 may be a device including a processor that performs computations and controls, and may be embodied, for example, by a micro controller unit. Or, the processor provided in the computation and control processor 20 may include an application specific integrated circuit (ASIC). In the present embodiment, the computation and control processor 20 is embodied by an integrated circuit (IC).

The functions of the signal processing unit 21, the temperature measurement unit 22, and the correction processing unit 23 may be embodied by software or by hardware. For example, one or more programs may be stored in the storage unit 24. Once a program stored in the storage unit 24 is read by the processor provided in the computation and control processor 20, the program may cause the processor to function as the signal processing unit 21, the temperature measurement unit 22, and the correction processing unit 23.

The signal processing unit 21 obtains an electrical signal from the infrared sensor 11 corresponding to the detected infrared radiation intensity. The signal processing unit 21 then calculates the temperature of the object being measured from the electrical signal using the calculation formula. The calculation formula is an expression (function) that calculates the temperature of the object being measured from the electrical signal corresponding to the infrared radiation intensity. Here, the infrared sensor 11 has a large temperature characteristic. Therefore, the calculation formula includes a modification term corresponding to the temperature of the infrared sensor 11. The calculation formula is expressed, for example, as in Expression (1) below.

T_{obj}=CNV{G(Ts−β)×(Ip×α−F(Ts−β))} Expression (1)

where T_{obj} is the temperature of the object being measured. CNV indicates a function for conversion, which may be, for example, a polynomial of degree of four or higher. Ts is the temperature of the infrared sensor 11. G and F are functions corresponding to the modification terms used within the CNV. Ip is the electrical signal from the infrared sensor 11. In addition, α and β are coefficients in the calculation formula. α corresponds to the gain. β corresponds to the offset.

The temperature measurement unit 22 measures the temperature of infrared sensor 11. The temperature measurement unit 22 outputs temperature information, which is a signal indicating the measured temperature. The temperature information may indicate temperature directly, or it may be a value corresponding to the temperature (as an example, a voltage value that varies in proportion to temperature). The temperature measurement unit 22 is not limited to a certain type and may be of any known configuration. The temperature measurement unit 22 may be configured to include a temperature sensor using, for example, the temperature coefficient of the diode forward voltage Vf of a semiconductor integrated in the computation and control processor 20.

As illustrated in FIG. 3, the infrared sensor 11 and the computation and control processor 20 are disposed so as to be stacked. The main surface of the computation and control processor 20 in contact with the infrared sensor 11 is hereinafter referred to as the first surface 81. Furthermore, the main surface of the computation and control processor 20 opposite to the first surface 81 is referred to as the second surface 82. The temperature measurement unit 22 may be disposed in the vicinity of the first surface 81 so that the temperature of the infrared sensor 11 can be accurately measured. In other words, the temperature measurement unit 22 may be included in the computation and control processor 20 and is disposed in close proximity to the infrared sensor 11. In the infrared sensor 11, a light-receiving element is provided facing the first surface 81, and an electrical signal corresponding to infrared radiation that is incident is output from the surface where the light-receiving element is disposed and which faces the first surface 81. The output electrical signal is output via an output electrode PAD of the infrared sensor 11 to an input electrode PAD of the computation and control processor 20. The input electrode PAD of the computation and control processor 20 is disposed on the first surface 81 and may be connected to the output electrode PAD of the infrared sensor 11 by a connection bump or the like. In the example in FIG. 3, the light-receiving element is disposed on the side of one surface of the infrared sensor 11, and the temperature measurement unit 22 included in the electronic circuit is disposed on the side of one surface of the computation and control processor 20. The infrared sensor 11 and the computation and control processor 20 are stacked so that the side of the one surface of the infrared sensor 11 and the side of the one surface of the computation and control processor 20 face each other and the temperature measurement unit 22 are in close proximity and face each other. In this manner, the infrared sensor 11 and the computation and control processor 20 is preferably stacked so that the light-receiving element and the temperature measurement unit 22 are in close proximity and face each other.

The correction processing unit 23 performs temperature correction to correct the coefficients of the calculation formula used in the calculation of the temperature of the object being measured. As described above, the temperature correction may be performed, for example, during manufacturing or before shipping of the infrared module 10 or electronic device. Details of temperature correction will be described below.

The storage unit 24 is one or more memories. The memory can be any type, including, but not limited to, semiconductor memory, magnetic memory, or optical memory, for example. The storage unit 24 stores various data used in the various processes performed by the computation and control processor 20. The storage unit 24 may also store the results and intermediate data of various calculations performed by the computation and control processor 20.

In the present embodiment, the storage unit 24 stores calculation formulae used in calculations of the temperature of the object being measured. When the correction processing unit 23 corrects the coefficients in the calculation formulae, it stores the corrected coefficients in the storage unit 24. The storage unit 24 may also store programs to enable the computation and control processor 20 to function as the signal processing unit 21, the temperature measurement unit 22, and the correction processing unit 23.

The communication unit 25 includes one or more communication modules to communicate with devices external to the infrared module 10 (hereinafter “external devices”). In the present embodiment, the external devices may include a controller that heats the heating element 60 to heat the object being measured to a set temperature while temperature correction is carried out. In temperature correction, a blackbody may be used as the object being measured, and the controller may regulate the temperatures of the blackbody to, for example, 30° C. and 45° C. In the present embodiment, the communication unit 25 includes an I2C communication module to communicate with the controller. In addition to the I2C, the communication unit 25 may also include a communication module compliant with mobile communication standards, wireless LAN standards, or wired LAN standards, to communicate with other external devices.

The heating element 60 regulates the temperature of the infrared sensor 11 by generating heat. The heating element 60 is disposed in the vicinity of the second surface 82 and can raise the temperature of the infrared sensor 11 via the computation and control processor 20. Here, since the temperature measurement unit 22 incorporated in the computation and control processor 20 is on the first surface 81, the temperature measurement unit 22 is in close proximity to the infrared sensor 11 and can measure the temperature of the infrared sensor 11 more accurately.

As illustrated in FIG. 3, the main surface of the substrate 70 closer to the computation and control processor 20 is hereinafter referred to as the front surface 71. The main surface of the substrate 70 opposite to the front surface 71 (the main surface farther from the computation and control processor 20) is referred to as the back surface 72. In the present embodiment, the heating element 60 is wiring disposed on the surface of the substrate 70 in contact with the second surface 82, i.e., the front surface 71. However, the heating element 60 is not limited to the wiring on the substrate 70.

FIG. 4 is a drawing illustrating an example configuration of the heating element 60. The left figure in FIG. 4 illustrates the electric al connections and the heating element 60 on the front surface 71 of the substrate 70. The right figure in FIG. 4 illustrates the terminals and the like on the back surface 72 of the substrate 70. On the front surface 71 of the substrate 70, electrical connections are established through wire bonding or other means with the terminals on the first surface 81 of the computation and control processor 20. FVDD, VDD, and VSS indicate signals related to power supply. INTN, SDA, and SCL indicate signals related to communications. The terminals for the signals of the infrared module 10 are arranged as illustrated in the right figure in FIG. 4, and are connected to external devices, for example, to send and receive signals. Here, “P1” is a terminal for conducting a current for heating the heating element 60, and the heating element 60 generates heat when the above-described controller conducts a current to P1 while temperature correction is carried out. Although the heating element 60 connects P1 to VSS in the example in FIG. 4, P1 may be connected to another power supply terminal (e.g., VDD) or a terminal of another signal (e.g., INTN) included on the substrate 70. In addition, the heating element 60 is disposed so as to traverse the infrared sensor 11 in a plan view that allows the infrared sensor 11 and the computation and control processor 20 to seen through. Wiring thicker than wiring for other signal lines is used for the heating element 60 in order to increase the amount of heat generated by the heating element 60 by increasing the current flowing through it.

FIG. 5 is a diagram illustrating another configuration of heating element 60. The number of terminals for conducting a current to the heating element 60 is not limited to one as illustrated in FIG. 4, but there may be multiple terminals. In the example in FIG. 5, two terminals, P1 and P2, are provided for conducting a current for heating the heating element 60. However, there may be three or more terminals for conducting a current through the heating element 60. As illustrated in the left figure in FIG. 5, the heating element 60 is branched to connect P1 and P2 so that the area where heat is generated is expanded compared to the example in FIG. 4. This makes it possible to raise the temperature of the infrared sensor 11 even more efficiently.

The substrate 70 is a land grid array (LGA) substrate in the present embodiment, but this is not limiting. The substrate 70 may be, for example, a ball grid array (BGA) substrate.

Here, the infrared sensor 11 and the computation and control processor are stacked and packaged in the present embodiment, so that heat conductivity in the z-axis direction is high. Thus, the temperature of the infrared sensor 11 can be raised sufficiently rapidly without the need for conducting a high current to through the heating element 60. The value of thermal resistance in the z-axis direction is 50° C./W to 100° C./W as an example, and the temperature of the infrared sensor 11 may be raised by about 10° C. by supplying power of 0.1 to 0.2 W.

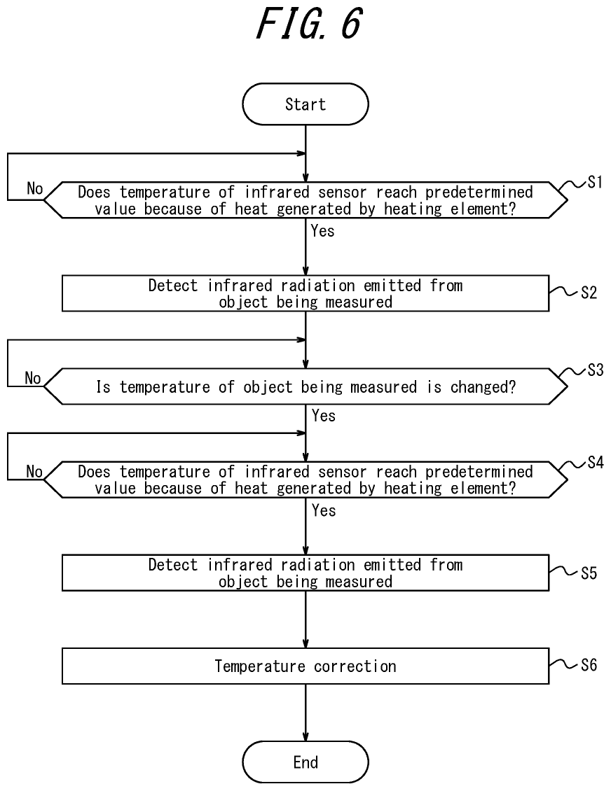

FIG. 6 is a flowchart illustrating the processes of a method of correcting the infrared module 10. The method of correcting the infrared module 10 may be initiated when the above-described controller, which is an external device for performing temperature correction, for example, is connected to the infrared module 10 and a start signal is sent from the controller via a communication compliant with I2C.

The correction processing unit 23 waits until the temperature of the infrared sensor 11 reaches a predetermined value due to the heat of the heating element 60 (No in Step S1). The temperature of the infrared sensor 11 is obtained based on temperature information from the temperature measurement unit 22. When the temperature of the infrared sensor 11 reaches the predetermined value (Yes in Step S1), the correction processing unit 23 obtains a first detection value of infrared radiation emitted from an object being measured (Step S2). Here, a detection value of infrared radiation is sometimes referred to as the infrared detection value and a detection value of the temperature is sometimes referred to as the temperature detection value. As described above, the temperature detection value is output from the temperature measurement unit 22.

The correction processing unit 23 waits until the temperature of the object being measured is changed by the controller (No in Step S3). The change in the temperature of the object being measured can be confirmed through an I2C communication with the controller. After the temperature of the object being measured is changed (Yes in Step S3), the correction processing unit 23 waits until the temperature of the infrared sensor 11 reaches a predetermined value due to the heat of the heating element 60 (No in Step S4). When the temperature of the infrared sensor 11 reaches the predetermined value (Yes in Step S4), the correction processing unit 23 obtains a second detection value of infrared radiation emitted from the object being measured (Step S5).

The correction processing unit 23 performs temperature correction based on the first detection value and the second detection value (Step S6). The temperature correction is carried out by modifying the coefficients in the above calculation formula (Expression (1)). It is assumed that the predetermined value of the temperature of the infrared sensor 11 is “C”. The temperature of the object being measured based on the first detection value (Ip₁) is T_{obj1}. The temperature of the object being measured based on the second detection value (Ip₂) is T_{obj2}. In this case, the following equations (2) and (3) are obtained.

T_{obj1}=CNV{G(C−β)×(Ip₁×α−F(C−β))} Expression (2)

T_{obj2}=CNV{G(C−β)×(Ip₂×α−F(C−β))} Expression (3)

The correction processing unit 23 can perform temperature correction by determining α from the expressions (2) and (3). The same process can be performed to obtain β by using a predetermined value of the temperature of the infrared sensor 11 different from “C”. In this way, the computation and control processor 20 may perform a correction method that includes the following three processes. First, as a first process, the computation and control processor 20 obtains, when the temperature of the infrared sensor 11 reaches a first predetermined value due to the temperature of the environment or heat generated by the heating element 60, a first infrared detection value of the detected infrared radiation emitted from an object being measured and a first temperature detection valued of the temperature measurement unit 22. As a second process, the computation and control processor 20 obtains, when the temperature of the infrared sensor 11 reaches a second predetermined value due to heat generated by the heating element 60, a second infrared detection value of the detected infrared radiation emitted from the object being measured and a second temperature detection value of the temperature measurement unit 22. As a third process, the computation and control processor 20 performs temperature correction based on the first infrared detection value, the first temperature detection value, the second infrared detection value, the second temperature detection value.

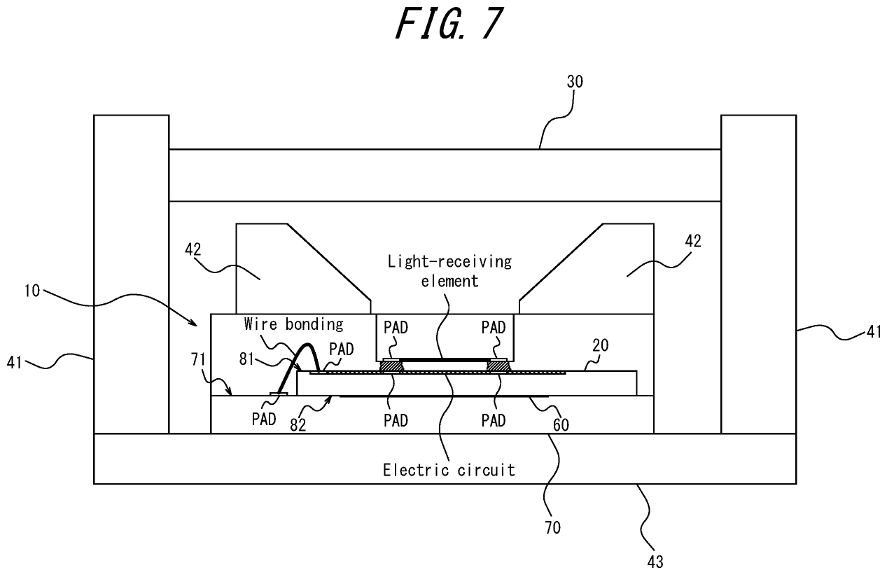

FIG. 7 illustrates an example of mounting of the infrared module 10. The infrared module 10 as a non-contact thermometer is mounted inside a housing of an earphone as illustrated in FIG. 7. The housing may include a wall 41 and a PCB board 43. A window material 30 may be disposed slightly inward from the housing of the earphone 40 to avoid direct contact with human skin. A viewing angle limiter 42 may be disposed above the infrared module 10 to prevent entry of infrared radiation from areas other than the object being measured. A structure may be adopted where the housing of the earphone 40, which comes into direct contact with the human body, and the window material 30 are spaced apart from the human body, so that the temperature of the infrared module 10 is less affected by the human body.

As described above, the infrared module 10 and the method of correcting the infrared module 10 can readily regulate the temperature of the infrared sensor 11 using the configuration and processes set forth above.

Although an embodiment of the present disclosure has been described based on the drawings and examples, it should be noted that one skilled in the art can easily make various changes or modifications based on the present disclosure. Thus, it should be noted that such variations or modifications are encompassed within the scope of the present disclosure. For example, the functions included in each component can be rearranged in a logically consistent manner, or multiple elements can be combined into one, or one elements may be divided.

Although the heating element 60 has been described to be packaged together with the infrared sensor 11, the computation and control processor 20, and the substrate 70 in the above embodiment, the infrared module 10 may be configured without the substrate 70. In this case, the heating element 60 may be disposed in the vicinity of the second surface 82. For example, it may be wiring on the second surface 82 or wiring that passes through the inside of the computation and control processor 20 that is disposed on the side of the first surface 81. Here, the wiring on the second surface 82 may be, for example, a redistribution layer (RDL). Or, the heating element 60 may be wiring on the PCB board 43. The wiring passing through the inside of the computation and control processor 20 may be, for example, wiring inside an IC. In the case where it is wiring inside an IC, the wiring is thicker than other signal lines in order to increase the current flow to thereby increase the amount of generated heat.

1. An infrared module comprising:
an infrared sensor that detects infrared radiation emitted from an object being measured;
a computation and control processor comprising a temperature measurement unit that obtains a signal from the infrared sensor and measures a temperature of its own, the computation and control processor obtaining a temperature signal from the temperature measurement unit and performing a computation; and
a heating element that regulates a temperature of the infrared sensor by generating heat,
wherein the infrared sensor and the computation and control processor are stacked.

2. The infrared module according to claim 1, wherein
a light-receiving element is disposed on a side of one surface of the infrared sensor,
the temperature measurement unit is disposed on a side of one surface of the computation and control processor, and
wherein the infrared sensor and the computation and control processor are stacked such that the side of the one surface of the infrared sensor and the side of the one surface of the computation and control processor face each other and the light-receiving element and the temperature measurement unit face each other and are in close proximity.

3. The infrared module according to claim 1, wherein the heating element is disposed in the vicinity of a second surface of the computation and control processor opposite to a first surface that is in contact with the infrared sensor.

4. The infrared module according to claim 1, comprising
a substrate comprising a terminal for conducting a current to the heating element,
wherein the heating element is wiring disposed on a surface of the substrate in contact with the second surface, and the substrate having the heating element is packaged together with the infrared sensor and the computation and control processor.

5. The infrared module according to claim 4, wherein a plurality of terminals for conducting the current to the heating element are disposed.

6. The infrared module according to claim 1, wherein the heating element is disposed so as to traverse the infrared sensor in plan view.

7. A method of correcting an infrared module comprising an infrared sensor that detects infrared radiation emitted from an object being measured, a computation and control processor comprising a temperature measurement unit that obtains a signal from the infrared sensor and measures a temperature of its own, the computation and control processor obtaining a temperature signal from the temperature measurement unit and performing a computation, and a heating element that regulates a temperature of the infrared sensor by generating heat,
the method comprising the steps of, by the computation and control processor:
obtaining, when the temperature of the infrared sensor reaches a first predetermined value due to a temperature of the environment or heat of the heating element, a first infrared detection value of detected infrared radiation emitted from the object being measured and a first temperature detection value of the temperature measurement unit;
obtaining, when the temperature of the infrared sensor reaches a second predetermined value due to heat of the heating element, a second infrared detection value of detected infrared radiation emitted from the object being measured and a second temperature detection value of the temperature measurement unit; and
performing temperature correction based on the first infrared detection value, the first temperature detection value, the second infrared detection value, and the second temperature detection value,
wherein, in the infrared module,
the infrared sensor and the computation and control processor are stacked.

8. The method of correcting an infrared module according to claim 7, wherein the infrared sensor and the computation and control processor are stacked so that a light-receiving element and the temperature measurement unit face each other and are in close proximity.

9. The method for correcting an infrared module according to claim 7, wherein the heating element is disposed in the vicinity of a second surface of the computation and control processor opposite to a first surface that is in contact with the infrared sensor.

10. The method of correcting an infrared module according to claim 7,
wherein a substrate comprising a terminal for conducting a current to the heating element is provided, and
the heating element is wiring disposed on a surface of the substrate in contact with the second surface, and the substrate having the heating element is packaged together with the infrared sensor and the computation and control processor.
